(19) United States
(12) Patent Application Publication
(10) Pub. No.: US 2015/0314151 A1
(43) Pub. Date: Nov. 5, 2015

(54) PORTABLE SLOWLY DESCENDING ESCAPE EQUIPMENT

(71) Applicant: Jui-Lung Chang, Tainan City (TW)

(72) Inventor: Jui-Lung Chang, Tainan City (TW)

(21) Appl. No.: 14/268,782

(22) Filed: May 2, 2014

(51) Int. Cl. A62B 35/00

(52) U.S. Cl. CPC A62B 35/0093; A62B 35/0018; A62B 35/005

(57) ABSTRACT

A portable slowly descending escape equipment includes a portable carrier, a descending device and a decelerating device. The descending device includes an annular gear which is rotatable and disposed within the portable carrier and a safety rope winding around on the annular gear in such a way that the annular gear is rotated along with the release of the safety rope. The decelerating device includes a transmission gear set which engages with the annular gear in an internal space thereof and a power generator which is driven by the transmission gear set to reduce a releasing speed of the safety rope by a resistant moment of the power generator.

### FIELD OF THE INVENTION

The present invention relates to an escaping rope equipment, and more particularly to a portable slowly descending escape equipment.

### BACKGROUND OF THE INVENTION

With the progress of living standard and the change of living style, there are more and more people living in a tall building with several floors or several tens floor. However, an accident such as a fire accident is always happened unexpectedly, and it is even more difficult for the residents to escape if it happens in the tall buildings. Therefore, in order to prevent such unfortunate accidents from being happened, now the high-rise building usually is not only provided with an escaping route such as an emergency steps but also equipped with an escaping equipment such as a safety escaping rope.

The safety escaping rope is usually provided on the exterior side of the building such that it can be utilized by the people trapped in the building to get down to the ground when the emergency exit such as a safety ladder is impassable. A conventional escaping rope equipment is capable of carrying only one person at a time, so that a user has to wait until the previous user reaches the ground to use the equipment for the escape. It therefore causes an insufficiency for an emergency situation.

Moreover, a conventional escaping rope equipment generally requires an operation by a user himself/herself or an assisting person who is aside during the escape for preventing accidents of rapid dropping or of hanging in the middle of the air, so therefore there may have a possibility of unexpected accidents due to personal mistakes while in the manual operation.

### SUMMARY OF THE INVENTION

Accordingly, an object of the present invention is to provide a portable slowly descending escape equipment, which does not need any extra operation by allowing a user to use it individually to thus improve the escape efficiency, and which is able to eliminate the complicated operations and to automatically adjust the descending speed.

The present invention provides a portable slowly descending escape equipment, comprising: a portable carrier including a wearing member and a covering member, the wearing member being provided for an user to wear the portable carrier, and the covering member being fastened by the wearing member, wherein the covering member is equipped with an enclosed space; a descending device including an annular gear and a safety rope, wherein the annular gear, in which an interior space is allocated, is rotatable and disposed within the enclosed space, and one end side of the safety rope is fixed to a supporting means and the other end side of the safety rope winds around on the annular gear in such a way that the annular gear is rotated along with the release of the safety rope; and a decelerating device, which is disposed within the enclosed space, including a transmission gear set and a power generator, wherein the transmission gear set is disposed within the interior space of the annular gear and is engaged respectively to the annular gear and to an input gear of the power generator in such a way that the power generator is driven by the transmission gear set as long as the annular gear is rotated so as to reduce a releasing speed of the safety rope by a resistant moment of the power generator.

According to an embodiment of the present invention, the portable slowly descending escape equipment further comprises a fan device, which is connected to either one of the annular gear, the transmission gear set and the power generator, being disposed corresponding to a generator load of the power generator in such a way that the fan device is driven by either one of the annular gear, the transmission gear set and the power generator to create air flow for exhausting extra heat from the generator load.

According to an embodiment of the present invention, the wearing member is a cross shape strap.

According to an embodiment of the present invention, the covering member is a mesh member, which has a plurality of meshes.

According to an embodiment of the present invention, an outer peripheral portion of the annular gear is extendedly formed with a receiving frame on which the safety rope winds around.

According to an embodiment of the present invention, the transmission gear set is an acceleration gear set that is with an acceleration transmission ratio of the annular gear to the power generator.

According to an embodiment of the present invention, the transmission gear set including multiple intermediate gear sets, the input gear of the power generator is disposed substantially at a center of rotation of the annular gear, and the intermediate gear sets are respectively engaged between the input gear and the annular gear.

According to an embodiment of the present invention, a generator load of the power generator is provided with a plurality of resistance wires that is connected in parallel with each other.

By means of technical means of the present invention, every single user can use one respective portable slowly descending escape equipment individually without the necessity of waiting other users for sharing the same emergency escaping equipment, to thus improve the escape efficiency and thereby to alleviate the load of the conventional sharing emergency escaping equipment. Further, the portable slowly descending escape equipment of the present invention is capable of automatically adjusting the descending speed with an appropriate deceleration speed to thus provide a comfortable and safe descending performance.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram of using a portable slowly descending escape equipment according to an embodiment of the present invention;

FIG. 2 is a cross-section view of the portable slowly descending escape equipment according to the embodiment of the present invention; and

FIG. 3 is another cross-section view of the portable slowly descending escape equipment according to the embodiment of the present invention.

### DETAILED DESCRIPTION OF THE PREFERRED EMBODIMENTS

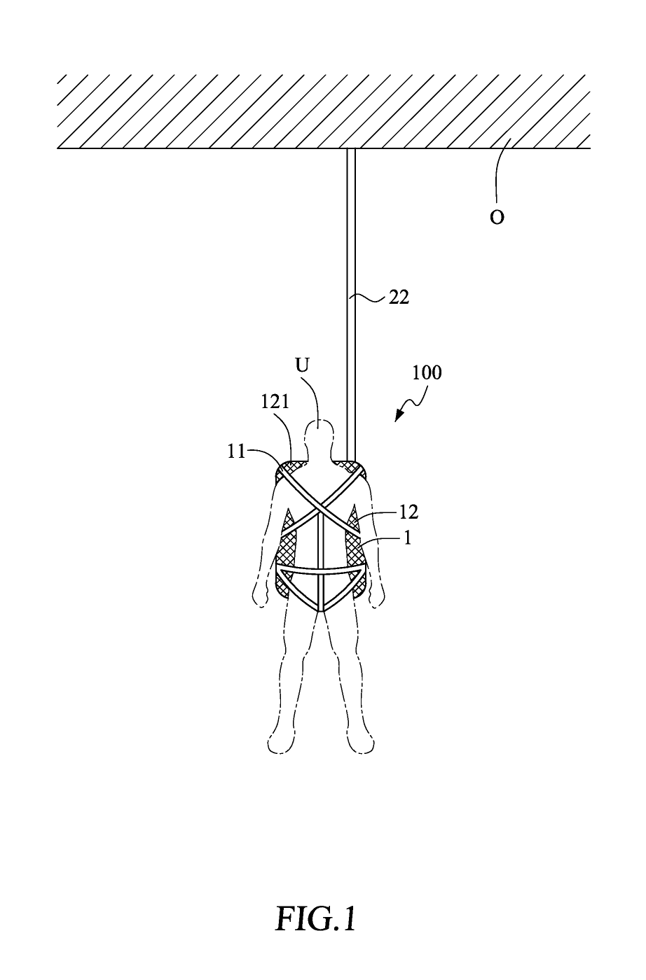

Embodiments are described in detail below with reference to the FIG. 1 to FIG. 3, and the description is used for explaining the embodiments of the present invention only but not for limiting the scope of the claims.

As shown in FIG. 1 to FIG. 3, a portable escape slowing descending equipment 100 according to an embodiment of the present invention comprising: a portable carrier 1 including a wearing member 11 and a covering member 12, the wearing member 11 being provided for an user U to wear the portable carrier 1, and the covering member 12 being fastened by the wearing member 11, wherein the covering member 12 is equipped with an enclosed space 120; a descending device 2 including an annular gear 21 and a safety rope 22, wherein the annular gear 21, in which an interior space 210 is allocated, is rotatable and disposed within the enclosed space 120, and one end side of the safety rope 22 is fixed to a supporting means O and the other end side of the safety rope 22 winds around on the annular gear 21 in such a way that the annular gear 21 is rotated along with the release of the safety rope 22; and a decelerating device 3, which is disposed within the enclosed space 120, including a transmission gear set 31 and a power generator 32, wherein the transmission gear set 31 is disposed within the interior space 210 of the annular gear 21 and is engaged respectively to the annular gear 21 and to an input gear 321 of the power generator 32 in such a way that the power generator 32 is driven by the transmission gear set 31 as long as the annular gear 21 is rotated so as to reduce a releasing speed of the safety rope 22 by a resistant moment of the power generator 32.

As shown in FIG. 1, the portable carrier 1 is formed as a bag in which the covering member 12 is a body of the bag and the wearing member 11 is a strap, so that a user U can wear the portable escape slowing descending equipment 100 as easy as wearing a bag to thus get ready quickly for an escape. Preferably, the wearing member 11 is a cross shape strap, which can be tightly fastened to a user U by winding around the user's body and four limbs to prevent the portable carrier 1 from coming off. Preferably, the covering member 12 is a mesh member, which has a plurality of meshes 121 to facilitate ventilation for a better heat dissipation of internal devices.

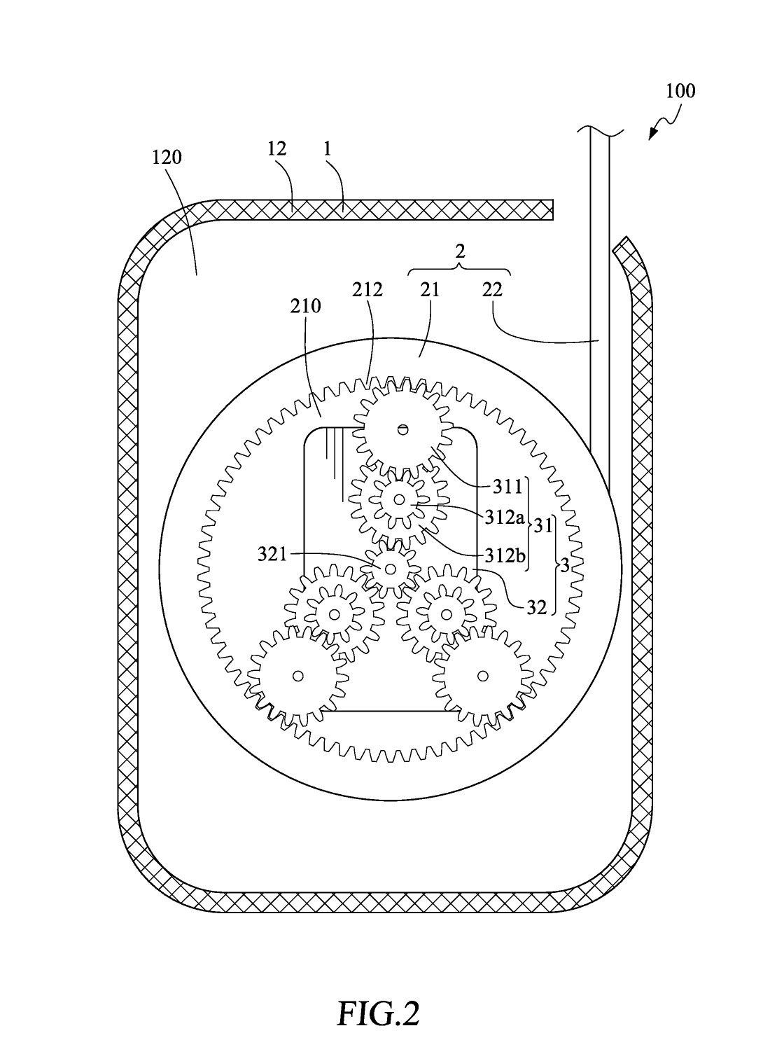

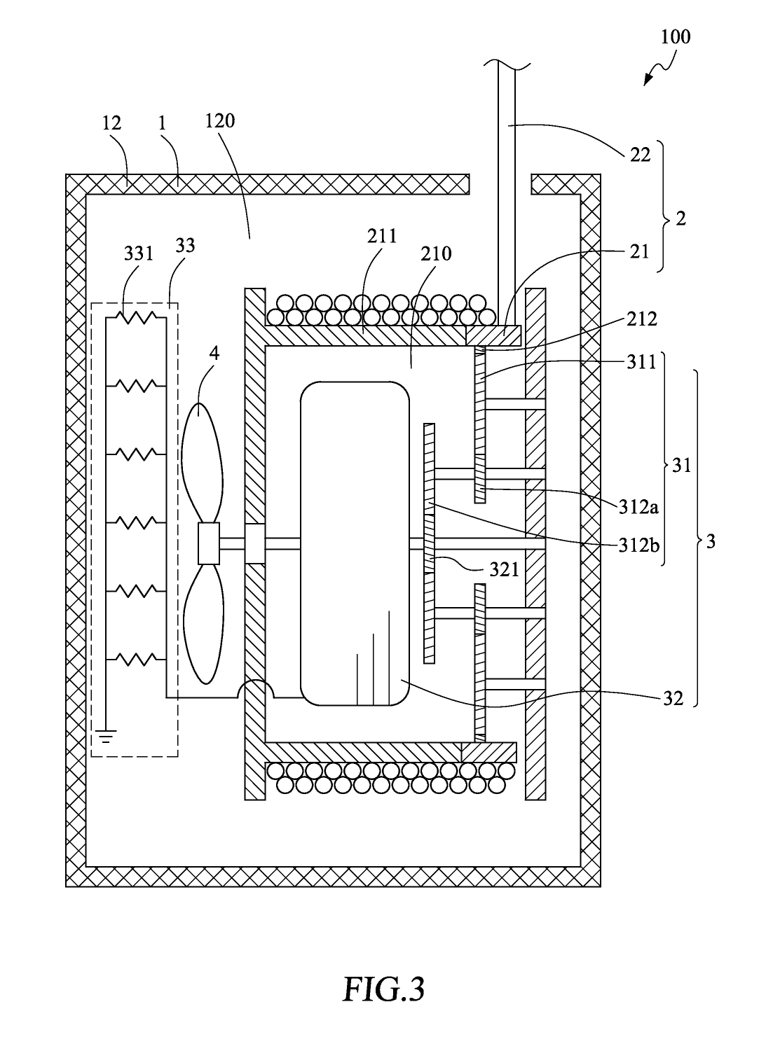

As shown in FIG. 2 and FIG. 3, the annular gear 21 of the descending device 2 is disposed within the enclosed space 120 of the covering member 12. An outer peripheral portion of the annular gear 21 is formed extending with a receiving frame 211 on which the safety rope 22 is wound around. An inner peripheral portion of the annular gear 21 is formed with internal teeth 212 that engage with the decelerating device 3. One end side of the safety rope 22 winds around on the receiving frame 211 and the other end side of the safety rope 22 is extended out of the covering member 12 to fix on the supporting means O directly or through an attachment. In a practical implementation, right after the safety rope 22 is fixed on the supporting means O, a user U who wears the portable carrier 1 can start to escape.

As shown in FIG. 2 and FIG. 3, the transmission gear set 31 of the decelerating device 3 is disposed within the interior space 210 of the annular gear 21. Such an arrangement effectively saves space so that the size of the covering member 12 and even the whole portable escape slowing descending equipment 100 can become smaller for conveniently carrying and wearing the equipment. Preferably, the entire decelerating device 3 can be disposed within the interior space 210 for further space saving.

As shown in FIG. 2 and FIG. 3, the transmission gear set 31 may include multiple intermediate gear sets, and in this embodiment, three sets of intermediate gears are provided. The input gear 321 of the power generator 32 is disposed substantially at a rotating center position of the annular gear 21, and the intermediate gear sets are respectively engaged between the input gear 321 and the annular gear 21 in such a way that a rotational energy of the annular gear 21 can be transmitted to the input gear 321 to drive the power generator 32. By means of providing multiple intermediate gear sets, applying forces from the transmission gear set 31 to the input gear 321 are equal in all directions to form a balanced state that leads to a smooth transmission.

Further, in this embodiment, each intermediate gear set includes several gears 311, 312a, and 312b. The gear 311 is engaged with the internal teeth 212 of the annular gear 21, and the number of teeth of the gear 311 is less than the number of internal teeth 212 of the annular gear 21. The gear 312a is engaged with the gear 311, and the number of teeth of the gear 312a is less than the number of teeth of the gear 311. The gear 312b is a companion gear of the gear 312a, and is engaged with the input gear 321. And the number of teeth of the gear 312b is larger than the number of teeth of the gear 312a and that of the input gear 321. With such arrangement and design of the teeth number, the transmission gear set 31 is served as an acceleration gear set with an acceleration transmission ratio of the annular gear 21 to the power generator 32, to magnify the rotation transmitted from the annular gear 21 through the gears 311, 312a, and 312b in such a way that the power generator 32 can get a higher driving speed than the annular gear 21.

As shown in FIG. 3, the power generator 32 is provided with a generator load 33. When the input gear 321 is rotated, the power generator 32 is driven to generate power into the generator load 33. While the power generator 32 generates power, a resistant moment (torque) that resists the rotation of the power generator 32 is also produced. The value of the resistant moment is positively proportional to the rotation speed of the power generator 32 and to the amount of the generator load 33, and therefore the rotation speed of the power generator 32 will be slowed down by the resistant moment. Accordingly, the rotation speed of the annular gear 21 is reduced by the resistant moment of the power generator 32 through the input gear 321 and the transmission gear set 31, and therefore a releasing speed of the safety rope 22 is reduced. And then, as the releasing speed of the safety rope 22 is reduced, the rotation speed of the power generator 32 is also reduced, and therefore the resistant moment is decreased. As a result, the safety rope 22 will gradually reach a constant releasing speed for a user U to descend smoothly and safely to the ground. Further, as mentioned above, the transmission gear set 31 in this embodiment is an acceleration gear set that makes the rotation speed of the power generator 32 relatively higher than the annular gear 21 to produce a relative larger resistant moment, so that the releasing speed of the safety rope 22 can be reduced significantly.

As shown FIG. 3, the generator load 33 may generally include a resistance wire, to which an electrical energy generated from the power generator 32 is delivered and is then transferred into heat energy. Additionally, in order to prevent the generator load 33 from being out of function due to being blown while the power generator 32 is in operation, it is preferable to use a resistance wire with a high melting point. Preferably, the generator load 33 can be provided with a plurality of resistance wires 331 that is connected in parallel with each other to thus diverse and reduce the risk of blowing.

As shown in FIG. 3, the portable escape slowing descending equipment 100 may also include a fan device 4. The fan device 4 is disposed corresponding to the generator load 33 of the power generator 32 and, in this embodiment, is mechanically connected to the power generator 32 in such a way that the fan device 4 is driven by the power generator 32 to create air flow. However, the present invention is not limited to this, and the fan device 4 also can be connected to the annular gear 21 or the transmission gear set 31 in such a way that the fan device 4 is driven by the annular gear 21 or the transmission gear set 31 to create air flow for exhausting extra heat from the generator load 33 to thus prevent the temperature of the resistance wires 32 from rising to the melting point and being fused.

With above structure, a user U can use one portable slowly descending escape equipment 100 individually without necessity of waiting the sharing of the same emergency escaping equipment, to thus improve the escape efficiency and thereby to alleviate the load of the conventional shared emergency escaping equipment. Further, the portable slowly descending escape equipment 100 is capable of utilizing the resistant moment to automatically adjust the descending speed with an appropriate deceleration to thus provide a comfortable and safe descending performance.

The above description should be considered as only the discussion of the preferred embodiments of the present invention. However, a person with an ordinary skill in the art may make various modifications to the present invention. Those modifications still fall within the spirit and scope defined by the appended claims.

What is claimed is:

1. A portable escape slowing descending equipment, comprising:
a portable carrier including a wearing member and a covering member, the wearing member being provided for an user to wear the portable carrier, and the covering member being fastened by the wearing member, wherein the covering member is equipped with an enclosed space;
a descending device including an annular gear and a safety rope, wherein the annular gear, in which an interior space is allocated, is rotatable and disposed within the enclosed space, and one end side of the safety rope is fixed to a supporting means and the other end side of the safety rope winds around on the annular gear in such a way that the annular gear is rotated along with the release of the safety rope; and
a decelerating device, which is disposed within the enclosed space, including a transmission gear set and a power generator, wherein the transmission gear set is disposed within the interior space of the annular gear and is engaged respectively to the annular gear and to an input gear of the power generator in such a way that the power generator is driven by the transmission gear set as long as the annular gear is rotated so as to reduce a releasing speed of the safety rope by a resistant moment of the power generator.

2. The portable slowly descending escape equipment as claimed in claim 1, further comprising a fan device, which is connected to either one of the annular gear, the transmission gear set and the power generator, being disposed corresponding to a generator load of the power generator in such a way that the fan device is driven by either one of the annular gear, the transmission gear set and the power generator to create air flow for exhausting extra heat from the generator load.

3. The portable slowly descending escape equipment as claimed in claim 1, wherein the wearing member is a cross shape strap.

4. The portable slowly descending escape equipment as claimed in claim 1, wherein the covering member is a mesh member, which has a plurality of meshes.

5. The portable slowly descending escape equipment as claimed in claim 1, wherein an outer peripheral portion of the annular gear is formed extending with a receiving frame on which the safety rope is wound around.

6. The portable slowly descending escape equipment as claimed in claim 1, wherein the transmission gear set is an acceleration gear set that is with an acceleration transmission ratio of the annular gear to the power generator.

7. The portable slowly descending escape equipment as claimed in claim 1, wherein the transmission gear set including multiple intermediate gear sets, the input gear of the power generator is disposed substantially at a center of rotation of the annular gear, and the intermediate gear sets are respectively engaged between the input gear and the annular gear.

8. The portable slowly descending escape equipment as claimed in claim 1, wherein a generator load of the power generator is provided with a plurality of resistance wires that is connected in parallel with each other.
